(19) United States
(12) Patent Application Publication
(10) Pub. No.: US 2012/0016416 A1
(43) Pub. Date: Jan. 19, 2012

(54) Teething Glove

(76) Inventor: Lucille Frazier, Aberdeen, SD (US)

(21) Appl. No.: 13/027,490

(22) Filed: Feb. 15, 2011

Related U.S. Application Data
(60) Provisional application No. 61/365,415, filed on Jul. 19, 2010.

(51) Int. Cl. A61J 17/00

(52) U.S. Cl. 606/235

(57) ABSTRACT

A teething glove includes a body member having upper and lower ends. A wrist attachment member is connected to the lower end of the body member and includes an elongate configuration that is extendable about a user's wrist and length adjustable. A pair of finger sleeves is attached to the upper end of the body member and extends away therefrom, each finger sleeve having a generally tubular configuration defining an open proximal end and a closed distal end.

### CROSS REFERENCE TO RELATED APPLICATION

This non-provisional patent application claims the benefit of provisional application Ser. No. 61/365,415 filed on Jul. 19, 2010, titled Adjustable Teether Glove.

### BACKGROUND OF THE INVENTION

This invention relates generally to baby teething aids and, more particularly, to a teething glove that may be selectively and adjustably attached to the wrist of a toddler and used to soothe the sore gums of the toddler who is teething. The teething glove includes finger sleeves that may be gnawed or gummed down on to alleviate pressure experienced inside the gums.

Children experience great pressure and pain in their gums during periods of teething. To alleviate these pains, parents and caretakers supply their children with teething rings, pacifiers, and a variety of other similar products designed to provide comfort during the teething process. Toddlers typically suck, gnaw, or chew on these items in an effort to provide sufficient counter-pressure against the pressure under their gums.

Although assumably effective for their intended purposes, the existing products are often difficult to hold onto when they become wet, are frequently dropped and become unsanitary, are unavailable when the child needs to relieve gum pressure, or may become lost altogether.

Therefore, it would be desirable to have a teething glove that is attachable to a child's wrist so as to be consistently and continuously available when needed or desired. Further, if would be desirable to have a teething glove having finger sleeves so that a child may massage his own gums in the same manner as sucking on his own fingers. In addition, it would be desirable to have a teething glove that is adjustable to fit the wrist of children of different sizes.

### SUMMARY OF THE INVENTION

A teething glove according to a preferred embodiment of the present invention includes a body member having upper and lower ends. A wrist attachment member is connected to the lower end of the body member and includes an elongate configuration that is extendable about a user's wrist and length adjustable. A pair of finger sleeves is attached to the upper end of the body member and extends away therefrom, each finger sleeve having a generally tubular configuration defining an open proximal end and a closed distal end.

Therefore, a general object of this invention is to provide a teething glove that may be secured to the wrist of an infant or toddler who is teething.

Another object of this invention is to provide a teething glove, as aforesaid, having at least one finger sleeve into which a wearer's finger may be inserted.

Still another object of this invention is to provide a teething glove, as aforesaid, having a silicone construction that is soothing to the gums of a child when gnawing or gumming down on the finger sleeves.

Yet another object of this invention is to provide a teething glove, as aforesaid, having a length adjustable wrist attachment member so as to be securable on the wrists of differently sized children.

A further object of this invention is to provide a teething glove, as aforesaid, that is cost effective to produce and user friendly to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a rear perspective view of a teething glove according to a preferred embodiment of the present invention;

FIG. 2 is a front perspective view of the teething glove as in FIG. 1; and

FIG. 3 is a front view of the teething glove as in FIG. 2 in use on the hand of a child.

### DESCRIPTION OF THE PREFERRED EMBODIMENT

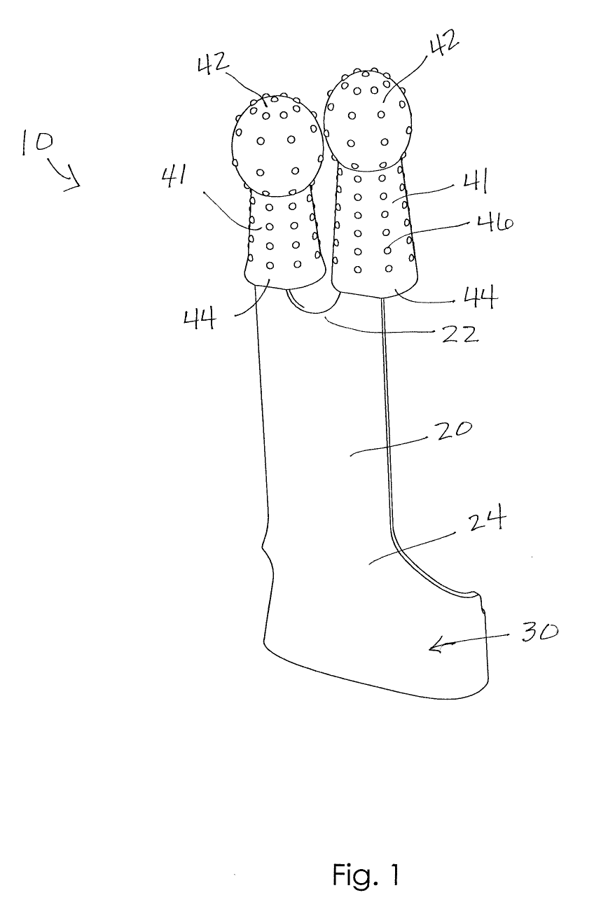

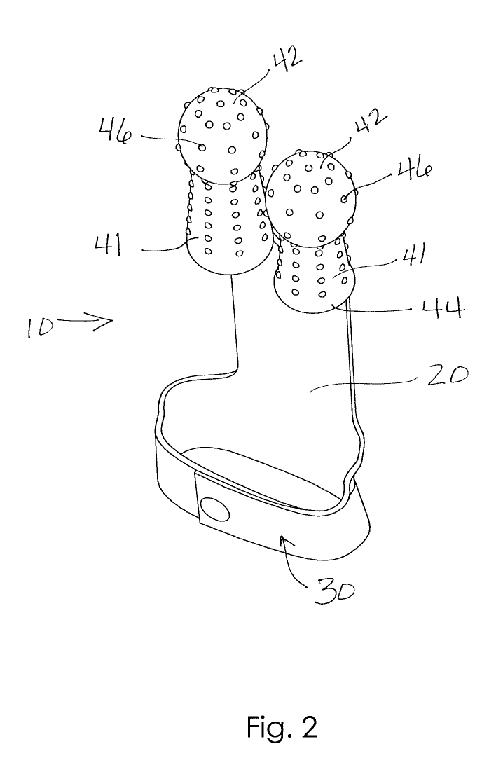

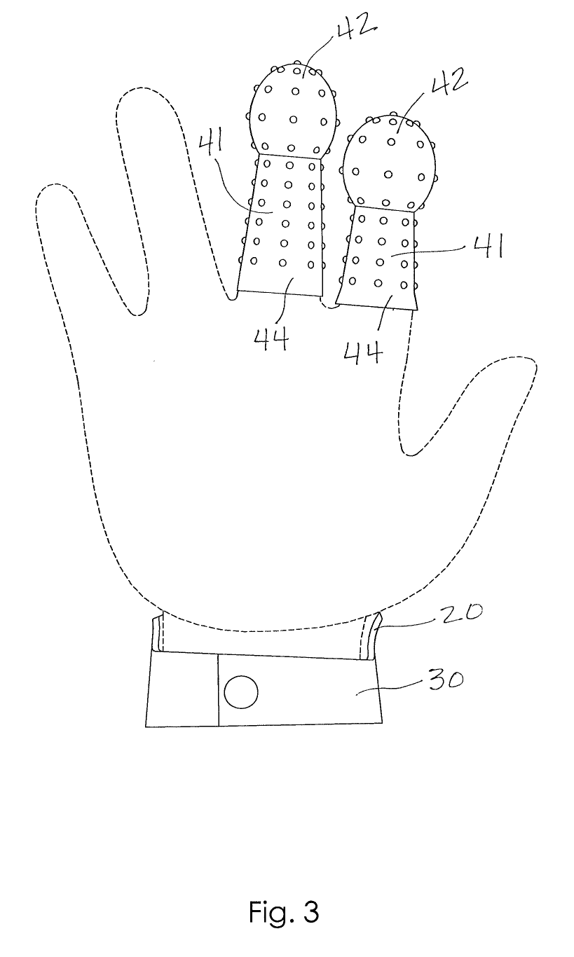

A teething glove according to the preferred embodiment of the present invention will now be described with reference to FIGS. 1 to 3 of the accompanying drawings. The teething glove 10 includes a body member 20, a wrist attachment member 30, and a pair 40 of finger sleeves.

The body member 20 includes upper 22 and lower 24 ends. Preferably, the body member 20 includes a generally planar configuration having a thin construction that is complementary to the back of an infant or toddler's hand. The body member 20 may have a generally rectangular shape although other configurations may also be suitable. The body member 20 may be constructed of a flexible silicone material although other generally flexible materials may also be used.

The wrist attachment member 30 is connected to the lower end 24 of the body member 20. The wrist attachment member 30 may include a unitary construction with the body member 20 or may be attached by stitching or the like. Preferably, the wrist attachment member 30 includes an elongate construction having opposed free ends that may be extended around the wrist of a child and then coupled together at a selected length. In other words, the wrist attachment member 30 may be a pair of straps that may be extended in opposite directions about a child's wrist and releasably coupled together with snaps, a clasp, a buckle, complementary hook and loop fasteners, or the like. Preferably, the wrist attachment member 30 is adjustable to at least three different sizes. Alternatively, the wrist attachment member 30 may be an elastic band that securely slips over the hand of a child and adapts to the size of the child's wrist. It is understood that when the wrist attachment member 30 is secured to a child's wrist, the body member 20 is positioned on the back of the child's hand.

The pair 40 of finger sleeves 41 is connected to the upper end 22 of the body member 20 and extends outwardly therefrom. Each finger sleeve 41 includes a generally tubular configuration having a closed distal end 42 and an open proximal end 44 relative to the body member upper end 22. Further, each finger sleeve 41 has an inner diameter that is complementary to the outer diameter of a child's finger so that a finger fits snugly when inserted therein. Each finger sleeve 41 also includes a length that is complementary to a length of a toddler's finger. The pair 40 of finger sleeves may also be constructed of flexible silicone so as to provide a balance of flexibility and rigidity.

In addition, an outer surface of each finger sleeve 41 may include a plurality of spaced apart nubs 46 so as to massage a child's gums when gumming down on the finger sleeves 41. Similarly, the distal end 42 of each finger sleeve 41 may include a bulbous or protruding configuration to further massage a child's gums in use. The bulbous end is preferably constructed of a hard silicone material as it is the most likely point at which a child may bite down on the finger sleeves. It is understood that a pair of finger sleeves is preferred but may include more or less sleeves.

One or both of the body member 20 and the pair 40 of finger sleeves 41 may include a plurality of spaced apart ventilation holes (not shown). Preferably, each ventilation hole is very small but capable of allowing ambient air to pass therethrough. This configuration assists in preventing wearing of the teething glove 10 from becoming hot, sweaty, or otherwise uncomfortable to a user.

In use, the teething glove 10 may be attached to a toddler's wrist and secured there for long periods of time without danger of being a choking hazard, become unduly soiled by being dropped, or becoming lost. Specifically, two of a child's fingers may be inserted into the open ends of respective finger sleeves 41 and the wrist attachment member 30 may then be adjustably coupled about the child's wrist. As the child's gums exert pressure from teeth yet below the gum surface, the child may simply insert his sleeved fingers into his mouth in order to gain the benefit of the nubbed surfaces of the finger sleeves.

It is understood that while certain forms of this invention have been illustrated and described, it is not limited thereto except insofar as such limitations are included in the following claims and allowable functional equivalents thereof.

1. A teething glove, comprising:
a body member having opposed upper and lower ends;
a wrist attachment member connected to said lower end of said body member, said wrist attachment member having an elongate configuration that is length adjustable; and
a pair of finger sleeves attached to said upper end of said body member and extending away therefrom, each finger sleeve having a generally tubular configuration defining an open proximal end and a closed distal end relative to said body member upper end.

2. The teething glove as in claim 1, wherein said wrist attachment member has a length sufficient to surround the wrist of a child.

3. The teething glove as in claim 2, wherein said body member includes a generally planar configuration that is complementary to a back of a child's hand.

4. The teething glove as in claim 3, wherein each tubular sleeve includes a length complementary to a length of a child's finger.

5. The teething glove as in claim 4, wherein said wrist attachment member is one of a strap, a buckle, a clasp, an elastic, snaps, and a hook and loop material.

6. The teething glove as in claim 5, wherein said wrist attachment member is adjustable to at least three different lengths.

7. The teething glove as in claim 5, wherein each tubular sleeve includes a plurality of spaced apart nubs.

8. The teething glove as in claim 5, wherein each tubular sleeve closed distal end includes a bulbous configuration.

9. The teething glove as in claim 1, wherein said body member and finger sleeves are constructed of silicone.

10. The teething glove as in claim 1, wherein said body member defines a plurality of holes through which ambient air may pass so as to provide ventilation to a user's hand.

11. The teething glove as in claim 10, wherein said pair of finger sleeves defines a plurality of holes through which ambient air may pass so as to provide ventilation to a user's fingers.
